(19) United States
(12) Patent Application Publication
(10) Pub. No.: US 2018/0070710 A1
(43) Pub. Date: Mar. 15, 2018

(54) Personal Carrier

(71) Applicant: Fatuma Yassin Sanneh, Detroit, MI (US)

(72) Inventor: Fatuma Yassin Sanneh, Detroit, MI (US)

(21) Appl. No.: 15/822,040

(22) Filed: Nov. 24, 2017

Related U.S. Application Data
(63) Continuation-in-part of application No. 14/988,744, filed on Jan. 5, 2016.

(51) Int. Cl. A45F 5/00; G06F 3/147

(52) U.S. Cl. CPC A45F 5/00; G06F 3/041; A45F 2005/008; G06F 3/147

(57) ABSTRACT

A personal carrier for carrying a communication device and personal items is provided. The personal carrier includes a first compartment for storing the communication device and a processing unit, wherein the processing unit electronically couples components of the personal carrier to the communication device. The personal carrier also includes a display surface configured to transmit information to and receive information from the communication device stored in the first compartment. The personal carrier further includes a second compartment for storing personal items and at least one strapping member for allowing the personal carrier to be worn or affixed to an object.

### CROSS-REFERENCE TO RELATED APPLICATIONS

The present application is a continuation-in-part and claims the benefit of U.S. patent application Ser. No. 14/988,744, titled “Personal Carrier,” filed Jan. 5, 2016, which is incorporated by reference herein in its entirety.

### BACKGROUND

Individuals are increasingly dependent on portable communications and/or entertainment devices. As such, individuals have a need to carry these communications and/or entertainment devices around while performing routine daily activities. In addition to communications and/or entertainment devices, individuals may have to carry other personal items, such as wallets, credit cards, driver license, keys and other personal effects during routine daily activities.

Some individuals may carry portable communications and/or entertainment devices and other personal items in a carrying case (for example, a purse or bag) as they perform routine daily activities. In such cases, in order to access a portable communications and/or entertainment device, the individual may have to retrieve the portable communications and/or entertainment device from the carrying case. In instances where an individual's hands are otherwise occupied, the individual may not be able to retrieve the portable communications and/or entertainment device from the carrying case.

There remains a need to provide a convenient hands-free means for carrying and having access to portable communications and/or entertainment device and other personal items.

### BRIEF DESCRIPTION OF THE DRAWINGS

FIG. 1 shows a multi-purpose, multi-compartment personal carrier used in accordance with some embodiments.

FIG. 2 shows an embodiment of the multi-purpose, multi-compartment personal carrier in accordance with some embodiments.

FIG. 3 shows a block diagram of a processing unit of the personal carrier in accordance with some embodiments.

FIG. 4 shows a side view of the personal carrier in accordance with some embodiments.

FIG. 5 shows a top view of the personal carrier in accordance with some embodiments.

FIG. 6 shows a bottom view of the personal carrier in accordance with some embodiments.

FIG. 7 shows an area of an upper compartment through which a device can be inserted into a dual-compartment carrier in accordance with some embodiments.

### DETAILED DESCRIPTION

Various methods and systems are disclosed to provide a multi-compartment personal carrier where items can be stored. The personal carrier may be worn on the arm and secured to a user's fingers and/or forearms. The personal carrier provides easy access to a communications and/or entertainment device which may be inserted into a compartment of the personal carrier. One or more other compartments or sub-compartments of the personal carrier may be used to store personal items such as currency, identification and personal effect.

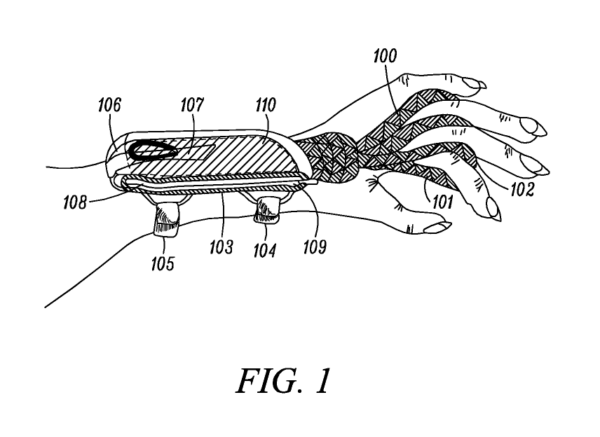

FIG. 1 shows a multi-purpose, multi-compartment personal carrier used in accordance with some embodiments. The personal carrier may include a compartment 106 for storing a portable communications and/or entertainment device and a compartment 108 for storing other personal items. The portable communications and/or entertainment device may be, for example, a smart phone, a mobile radio such as a police radio or an electronic gaming system.

Although FIG. 1 shows two compartments 106 and 108, in some embodiments, the personal carrier may include one or more compartments. In some embodiments, compartment 106 and/or compartment 108 may also include multiple sub-compartments (not shown for the sake of simplicity). Compartment 106 and/or compartment 108 may be selectively opened and closed using a fastener including, for example, a zipper, buttons, Velcro straps, and the like, in order to securely store the portable communications and/or entertainment device and/or other personal items stored in compartment 106 and/or compartment 108 and/or in any sub-compartments thereof. For example, compartment 106 may be opened and closed with a strap 107 and compartment 108 may be opened and closed with a zipper 109.

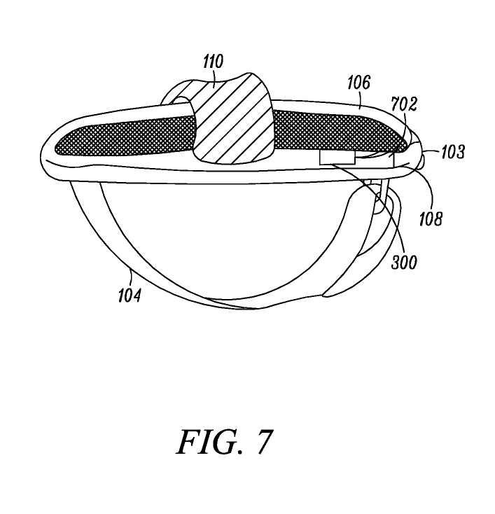

Compartment 106 may also be configured to include a power member 702 (shown in FIG. 7), for example a battery, for powering the portable communications and/or entertainment device. In some embodiments, power member 702 may be permanently affixed to compartment 106. In other embodiments, power member 702 may be removable from compartment 106, for example, to launder or otherwise clean the personal carrier. The power member 702 may be attached to the bottom 103 of the personal carrier or to the bottom or sides of compartment 106. The power member 702 may also include a connection member (not shown) that is accessible in compartment 106. The connection member may be, for example, a USB port for mating the power member with the portable communications and/or entertainment device in order the charge the portable communications and/or entertainment device when it is inserted into or stored in compartment 106. The power member 702 may also include a charging member (not shown) for connecting the power member 702 to a power source in order to charge the power member 702.

In some embodiments, the personal carrier may further include a display surface 110 (shown as a portion with diagonal lines) for viewing information shown on the portable communications and/or entertainment device and otherwise accessing the portable communications and/or entertainment device. Display surface 110 may be configured as a clear viewing area that is configured to show the entire viewing area/screen of the portable communications and/or entertainment device or otherwise correspond to the viewing area of the portable communications and/or entertainment device. Display surface 110 may be configured as a touch-capable surface that when touched is configured to activate the viewing area/screen or other interactive features of the portable communications and/or entertainment device while it is in compartment 106. For example, the touch-capable display surface 110 may be used to access a concept keyboard or other input devices, such as, a trackball, joystick, digital camera, and/or microphone of the portable communications and/or entertainment device while it is stored in compartment 106.

Consider, for example, that the smart phone stored in compartment 106 is ringing. Rather than require the user to remove the smart phone from compartment 106 in order to answer the call, the information on the smart phone may be shown on display surface 110. The user may then touch an appropriate area on the touch-capable display surface 110 that is directly over the viewing area/screen of the smart phone to accept the call. Similarly, if the user of the personal carrier wants to make a call or use other features of the smart phone, the user may touch the touch-capable display surface 110 that is directly over a portion of the viewing area/screen of the smart phone, wherein when display surface 110 is touched, it activates the portion of the viewing area/screen of the smart phone that when touched activates or otherwise accesses a feature of the smart phone.

In some embodiments, display surface 110 may be motion activated. Continuing with the example of receiving a call on a smart phone stored in compartment 106, the user of the personal carrier may accept or reject the call by moving the personal carrier in a predefined direction, for example, by moving the personal carrier to the right or left. Consider, for example, that the personal carrier is worn on the top of a hand, as shown in FIG. 1, by moving the wrist in a predefined direction, for example, leftward or upward, the display surface 110 may be configured to transmit an indication to the smart phone to accept the incoming call or by moving the wrist in a predefined direction, for example, rightward or downward, the display surface 110 may be configured to transmit an indication to the smart phone to reject the incoming call.

Display surface 110 may be configured to switch on or off and may also be configured to wirelessly connect with the portable communications and/or entertainment device. For example, display surface 110 may be wireless connected to the portable communications and/or entertainment device via, for example Bluetooth, near field communications (NFC) or the like, in order to wirelessly receive information from and transmit information to the portable communications and/or entertainment device. In some implementations, display surface 110 may be wirelessly connected to a portable communications and/or entertainment device while it is stored in compartment 106.

In other implementations, display surface 110 may be wireless connected to a portable communications and/or entertainment device that is not stored in compartment 106. For example, the portable communications and/or entertainment device may be stored in a purse worn by the user of the personal carrier and may be wirelessly connected to display surface 110. In such implementations, compartment 106 may be used to store personal items.

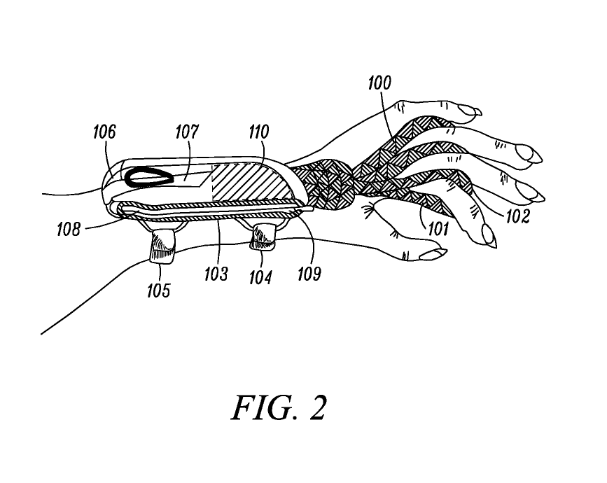

In some implementations, as shown for example in FIG. 2, display surface 110 may be configured to be less than the viewing area/screen of the portable communications and/or entertainment device. In other words, display surface 110 may be configured to not correspond to the viewing area of the portable communications and/or entertainment device. Consider again the example where the smart phone stored in compartment 106 is ringing. Rather than require the user to remove the smart phone from compartment 106 in order to activate portions of the viewing area/screen of the smart phone that are not accessible from display surface 110, the information on the smart phone may be transmitted to display surface 110 and thereafter shown on display surface 110. In such a case, display surface 110 may include an input member (not shown) (for example, a button, a concept keyboard, or other input device) that may be activated to accept or reject the call. The user may then touch the input member on display surface 110 to activate or accept the call. Similarly, if the user of the personal carrier wants to make a call or use other features of the smart phone, the user may then touch the appropriate input member on display surface 110 to allow the user to access features on the smart phone. The display surface 110 may then transmit information from the input member to the smart phone.

In another case where display surface 110 is configured to not correspond to the viewing area of the portable communications and/or entertainment device, display surface 110 may transmit information to the portable communications and/or entertainment device based on movements of the personal carrier.

In an implementation where display surface 110 is configured to not correspond to the viewing area of the portable communications and/or entertainment device, compartment 106 may be used to store personal items. In such an implementation, the portable communications and/or entertainment device may be stored separately from the personal carrier. The portable communications and/or entertainment device may be wirelessly connected to the personal carrier and the display surface 110 may be configured to transmit information to and receive information from the separately stored portable communications and/or entertainment device. In such an implementation, the personal carrier may only include one compartment, i.e., compartment 106.

The personal carrier may also include a processing unit 300 for electronically coupling components of the personal carrier to the electronic devices. For example, the processing unit 300 may enable display surface 110 to communicate with electronic devices stored in compartment 106 or otherwise wirelessly connected to display surface 110. In some implementations, the processing unit 300 may be affixed or otherwise connected to power member 702.

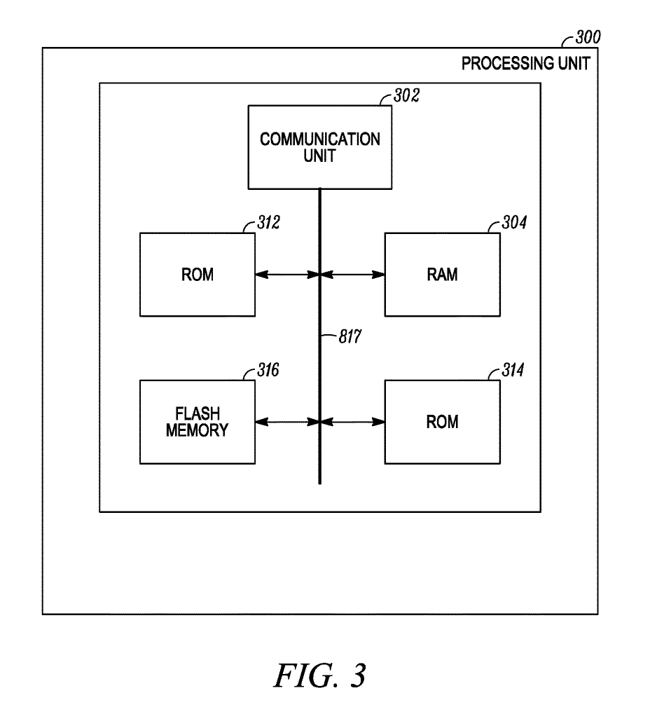

FIG. 3 shows a block diagram of the processing unit used in accordance with some embodiments. The processing unit 300 may include a communications unit 302 coupled to a common data and address bus 317. The processing unit 300 may also be electronically coupled to display surface 110 to cause processing unit 300 to be in communication with an input unit (e.g., keypad, pointing device, etc.), an output transducer unit (e.g., speaker), an input transducer unit (e.g., a microphone) (MIC), and a display screen, each of which may be components of display surface 110.

The processing unit 300 may include a code read-only memory (ROM) 312 for storing data for initializing system components. The processing unit 300 may further include one or more memory devices, such as a read only memory (ROM) 314, a random access memory (RAM) 304, and/or a static memory or flash memory 316. One or more of ROM 314, RAM 304 and flash memory 316 may be included as part of the processing unit 300 or may be separate from, and coupled to, the processing unit 300.

The communications unit 302 may include an interface configurable to communicate with network components and other user equipment within its communication range. Communications unit 302 may also include one or more local area network or personal area network transceivers perhaps operating in accordance with an IEEE 802.11 standard (e.g., 802.11a, 802.11b, 802.11g), or a Bluetooth transceiver. The one or more memory devices 312, 314 and 316 are configured to store non-transitory computer-executable instructions to perform a set of functions.

The personal carrier may also include one or more strapping members for allowing the personal carrier to be worn. Examples of strapping members may include loops, straps, and the like for strapping the personal carrier to a surface. Returning to FIGS. 1 and 2, for example, loops 100 and 101 of the personal carrier may be used to anchor the personal carrier to fingers 102. In FIGS. 1 and 2, straps 104 and 105 may be attached to the width of the personal carrier in order to secure the personal carrier to a forearm and wrist. It should be noted that the personal carrier may be configured to be worn on various parts of the body or the personal carrier may be configured to be affixed to one or more objects. As such, each of loops 100 and 101 of the personal carrier and/or straps 104 and 105 may be configured according to how the personal carrier is to be worn or affixed to an object.

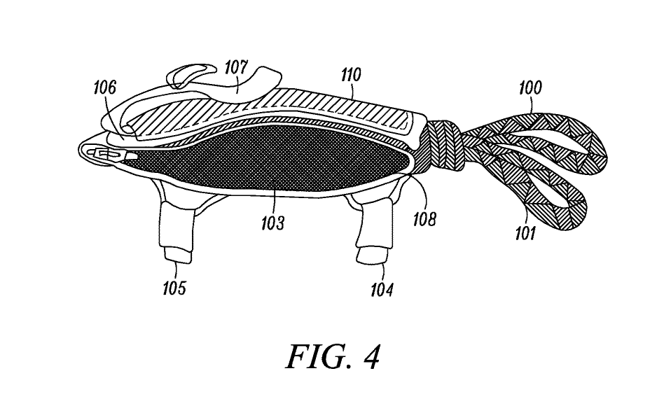

FIG. 4 shows a side view of the personal carrier in accordance with some embodiments. In FIG. 4, compartment 108 that may be used for storing other personal items is unzipped.

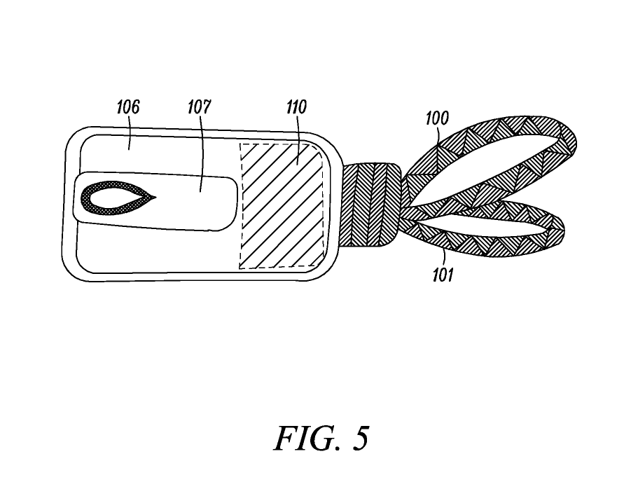

FIG. 5 shows a top view of the personal carrier in accordance with some embodiments. The display surface 110 of the personal carrier shown in FIG. 5 is configured to cover only a portion of the top surface of the personal carrier.

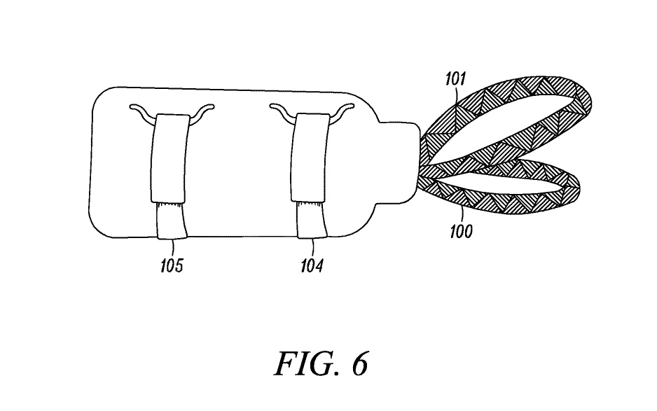

FIG. 6 shows a bottom view of the personal carrier in accordance with some embodiments. FIG. 6 shows how straps 104 and 105 may be fastened in order to secure the personal carrier to a body part, for example, a wrist.

FIG. 7 shows an area of an upper compartment 106 through which a device can be inserted into a dual-compartment carrier in accordance with some embodiments. In FIG. 7, a portion of display surface 110 is shown in order to show the configuration of compartment 106. The power member 702 and the processing unit 300 are shown as affixed to the side of compartment 106.

Various embodiments are described in this specification, with reference to the details discussed above, the accompanying drawings, and the claims. Numerous specific details are described to provide a thorough understanding of various embodiments. However, in certain instances, well-known or conventional details are not described in order to provide a concise discussion. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the embodiments.

The embodiments described and claimed herein and drawings are illustrative and are not to be construed as limiting the embodiments. The subject matter of this specification is not to be limited in scope by the specific examples, as these examples are intended as illustrations of several aspects of the embodiments. Any equivalent examples are intended to be within the scope of the specification. Indeed, various modifications of the disclosed embodiments in addition to those shown and described herein will become apparent to those skilled in the art, and such modifications are also intended to fall within the scope of the appended claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

All references including patents, patent applications and publications cited herein are incorporated herein by reference in their entirety and for all purposes to the same extent as if each individual publication or patent or patent application was specifically and individually indicated to be incorporated by reference in its entirety for all purposes.

What is claimed is:

1. A personal carrier for carrying a communication device and personal items, the personal carrier comprising:
a first compartment configured to store the communication device and a processing unit, wherein the processing unit is configured to electronically couple components of the personal carrier to the communication device;
a display surface electronically couple to the processing unit, wherein the display surface is configured to transmit information to and receive information from the communication device stored in the first compartment;
a second compartment for storing personal items; and
at least one strapping member for allowing the personal carrier to be worn or affixed to an object.

2. The personal carrier of claim 1, wherein each of the first compartment and the second compartment includes at least one sub-compartment.

3. The personal carrier of claim 1, wherein each of the first compartment and the second compartment is selectively accessed through a fastener.

4. The personal carrier of claim 1, wherein the first compartment includes a power member for powering the communication device stored in the first compartment when the communication device is mated with the power member.

5. The personal carrier of claim 1, wherein the display surface is configured to correspond to a viewing area of the communication device.

6. The personal carrier of claim 1, wherein the display surface is configured to not correspond to a viewing area of the communication device.

7. The personal carrier of claim 1, wherein the display surface is configured as a touch capable surface that when touch is configured to activate one or more features of the communication device stored in the first compartment.

8. The personal carrier of claim 1, wherein the display surface is motion activated.

9. The personal carrier of claim 1, wherein the display surface is configured to wirelessly connect to the communication device and to wirelessly receive information from and transmit information to the communication device

10. A personal carrier for carrying personal items and displaying information from and transmitting information to a communication device, the personal carrier comprising:
a first compartment configured to store the personal items and a processing unit configured to electronically couple components of the personal carrier to the communication device;
a display surface electronically couple to the processing unit, wherein the display surface is configured to transmit information to and receive information from the communication device; and
at least one strapping member for allowing the personal carrier to be worn or affixed to an object.
